(19) United States
(12) Patent Application Publication
(10) Pub. No.: US 2026/0180027 A1
(43) Pub. Date: Jun. 25, 2026

(54) ELECTROLYTE FORMULATIONS FOR LITHIUM-ION BATTERIES

(71) Applicant: SIONIC ENERGY, INC., Rochester, NY (US)

(72) Inventors: Gabriel Torres, Rochester, NY (US); Dai in PARK, Daejeon City (KR); Kevin Brown, JR., Rochester, NY (US); Alex Taylor, Rochester, NY (US); Rochit Sinha, Rochester, NY (US)

(21) Appl. No.: 19/427,442

(22) Filed: Dec. 19, 2025

Related U.S. Application Data
(60) Provisional application No. 63/737,444, filed on Dec. 20, 2024.
(60) Provisional application No. 63/737,468, filed on Dec. 20, 2024.
(60) Provisional application No. 63/737,474, filed on Dec. 20, 2024.

(51) Int. Cl. H01M 10/0567; H01M 4/36; H01M 4/525; H01M 4/62; H01M 10/0525; H01M 10/0568; H01M 10/0569

(52) U.S. Cl. CPC H01M 10/0567; H01M 4/366; H01M 4/525; H01M 4/624; H01M 10/0525; H01M 10/0568; H01M 10/0569; H01M 2300/004

(57) ABSTRACT

Electrolyte formulations for lithium-ion batteries are disclosed that enable high-voltage operation, improved cycle life, reduced impedance, and enhanced safety. The formulations comprise an aprotic organic solvent, a lithium salt, and an epoxide functionalized organic compound, and may further include additives such as organosulfur compounds, alkyl nitriles, fluorinated aliphatic esters, cyclic carbonates, partially fluorinated phenyl phosphate esters, and fluorinated cyclic phosphazenes. These components synergistically stabilize the cathode electrolyte interface (CEI), mitigate oxidative decomposition at elevated voltages, and impart flame-retardant properties. Electrochemical energy storage devices incorporating these formulations exhibit superior performance under high-voltage and high-temperature conditions, making them suitable for applications such as electric vehicles, aerospace systems, and grid storage.

### RELATED APPLICATIONS

This application claims priority to U.S. Provisional Application Nos. 63/737,444, filed Dec. 20, 2024; 63/737,468, filed Dec. 20, 2024; and 63/737,474, filed Dec. 20, 2024, the entire contents of each of which are incorporated herein by reference.

### FIELD

The present disclosure relates to electrolyte formulations that enable reduced battery resistance, increased cycle life, improved high-temperature performance; and electrochemical energy storage devices containing these electrolytes.

### BACKGROUND

Li-ion batteries are heavily used in consumer electronics, electric vehicles (EVs), as well as unmanned aerial systems (UAS) and EVTOL aircraft. Recently, Li-ion batteries with voltages above 4.35 V have gained importance because of higher capacity and subsequent energy density benefits. However, the stability of the cathode materials at these potentials reduces due to increased oxidation. This may result in electrochemical oxidation of the material resulting in gas evolution that can deteriorate the performance of the battery. Elements within the cathode active material may also dissolve in the non-aqueous electrolyte, resulting in a structural breakdown of the material, further leading to an increase in the interfacial resistance.

These Li-ion batteries are also typically exposed to extreme temperatures during their operation. The SEI (Solid Electrolyte Interface) layer formed on the anode is gradually broken down at high temperatures, and hence leads to more irreversible reaction resulting in capacity loss. Similarly, the CEI (Cathode Electrolyte Interface) will also lose stability at elevated temperatures. These reactions happen on the positive and negative electrode during cycling but are generally more severe at higher temperatures due to faster kinetics. The next generation Li-ion batteries used in consumer electronics, EVs, and UAS will require significant improvements in the electrolyte component relative to the current state-of-the art of Li-ion batteries.

The shuttling of positive and negative ions between the battery electrodes is the main function of the electrolyte. Historically, researchers have focused on developing battery electrodes, and electrolyte development has been limited. Traditional Li-ion batteries used carbonate-based electrolytes with a large electrochemical window that can transport lithium ions. These electrolytes need functional additives to passivate the anode and form a stable SEI, as well as additives for stabilizing the cathode. At the same time, there is a need to design and develop electrolyte formulations that allow stable and safe cycling of high voltage and high energy Li-ion batteries.

Lithium Cobalt Oxide (LCO) is a cathode for a high energy cathode with a high theoretical energy capacity of approximately 274 mAh/g. This material as a result has a specific energy that is useful for consumer electronics and UAS. However, to practically achieve a significant proportion of that capacity requires charging a full cell above conventional cut-off voltages to at least 4.45 V. Conventional electrolyte formulations will begin to oxidize and degrade at voltages at this cutoff, thus making the use of LCO cathode more challenging and undesirable.

U.S. Patent Application No. 20230344002A1 discloses that heterocyclic compounds comprising a sulfur atom can be useful for stabilizing the SEI in a lithium-ion battery cell. These compounds are disclosed to reduce before other compounds within the lithium-ion battery cell to produce a desirable SEI and prevent undesirable reduction products.

U.S. Patent Application No. US20230352736A1 discloses a class of materials including an epoxide ring structure, are capable of forming a CEI to improve cathode stability. These molecules with said functional groups can act as electrolyte additives to allow for the formation of a CEI that protects the cathode and electrolyte from degradation at high potentials.

Thus, improvement is still needed.

### SUMMARY

The present disclosure relates to electrolyte formulations for lithium-ion batteries that enable high-voltage operation, improved cycle life, reduced impedance, and enhanced safety. The formulations include an epoxide functionalized organic compound, an aprotic organic solvent, and a lithium salt, and may further comprise functional additives such as organosulfur compounds, alkyl nitriles, fluorinated aliphatic ester co-solvents, cyclic carbonates, partially fluorinated phenyl phosphate esters, and fluorinated cyclic phosphazenes. These components synergistically stabilize the cathode electrolyte interface (CEI), mitigate oxidative decomposition at elevated voltages, and impart flame-retardant properties that reduce thermal runaway risk. Electrochemical energy storage devices incorporating these formulations exhibit superior performance under high-voltage and high-temperature conditions, making them suitable for demanding applications such as electric vehicles, aerospace systems, and grid storage.

In some embodiments, the electrolyte formulation is optimized for lithium-ion cells operating at voltages of 4.30 V or higher for nickel-manganese-cobalt cathodes and 4.45 V or higher for lithium cobalt oxide cathodes. The combination of epoxide functionalized organic compounds with fluorinated co-solvents and flame-retardant additives provides oxidative stability, improved fast-charging capability, and enhanced abuse tolerance, enabling safe and efficient cycling of high-energy-density batteries.

These and other aspects of the present disclosure will become apparent upon a review of the following detailed description and the claims appended thereto.

### BRIEF DESCRIPTION OF THE DRAWINGS

FIG. 1 is a graph showing the dQ/dV profiles of electrolytes tested in LCO/Gr (graphite) cells in accordance with the present disclosure.

FIG. 2 is a graph showing the capacity retention cycle life plot of LCO/Graphite cells.

FIG. 3 is a graph showing the capacity retention cycle life plot of NMC/Graphite cells.

FIG. 4 is a graph showing the coulombic efficiency cycle life plot of NMC/Graphite cells.

FIG. 5 is a graph showing capacity retention cycle life plot of NMC/Graphite cells.

FIG. 6 is a graph showing the temperature of cells when undergoing hotbox testing.

FIG. 7 is a graph showing the capacity retention cycle life plot of LCO/Graphite+Si-Carbon cells.

### DETAILED DESCRIPTION

The present application relates generally to lithium-ion (Li-ion) battery electrolytes. Particularly, the disclosure is directed towards electrolyte formulations comprising an epoxide functionalized organic compound additive, an aprotic organic solvent, an additive that reduces between 0.8 and 2.5V relative to lithium, an alkyl nitrile, and a lithium salt; and electrochemical energy storage devices containing these electrolytes.

The present disclosure describes a Li-ion battery electrolyte with an electrolyte material that can overcome cathode stability challenges in Li-ion batteries, particularly those including cathode materials that operate at voltages above 4.35V. For context, at or above 4.35V is considered a high voltage application for Li-ion batteries. Current state-of-the-art Li-ion batteries include cathode materials that comprise LCO, a high energy cathode with a high theoretical energy capacity of approximately 274 mAh/g. There is a need to develop an electrolyte solution for cycling of Li-ion cells with high voltage, high energy cathodes. The present application relates to compounds including an epoxide functionalized organic compound that can improve the stability of high-voltage, high-energy cathodes. The electrolyte materials form a unique cathode electrolyte interface (CEI) and do not excessively passivate the cathode, when used at low weight loadings. Additionally, an improved CEI improves the high temperature performance and storage stability.

Adding the epoxide functionalized organic compound into the Li-ion battery system allows for the polymerization of said molecules at high temperature, and/or oxidation on the surface of the cathode in situ. The temperature range for the activation of these molecules is between 40° C. and 80° C., preferably at 60° C. The resulting polyether film coordinates with the anode or cathode material, which suppresses further reductive or oxidative decomposition of the rest of the electrolyte components that occurs otherwise in contact with the electrode.

In an aspect of the disclosure, the molecular structure of epoxide functionalized organic compound additive include at least one epoxide moiety covalently bonded to at least one cyclophosphazene moiety. The cyclophosphazene moiety coordinates with the Cobalt atom in the cathode molecular structure via the pi bond in the cyclophosphazene moiety. In doing so it inhibits contact between the electrolyte species and the cathode particle surface, preventing oxidation of the electrolyte formulation. At the same time, the cyclophosphazene moiety is covalently bonded to the epoxide structure, which in turn polymerizes into a polyethylene oxide structure at elevated temperatures. These molecules are thus attached to the cathode while covering it fully with a polymer that conducts lithium-ions, resulting in a low resistance interface that prevents oxidation.

In an aspect of the disclosure, the epoxide functionalized organic compound has a molecular structure represented by formula (I):

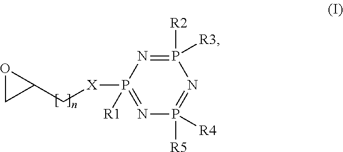

wherein n is an integer from 1 to 8; X is oxygen or sulfur; R1, R2, R3, R4, and R5 are independently selected from a halogen atom, an optionally substituted C₁-C₁₂ alkyl ether, an optionally substituted C₆-C₁₄ aryl ether, an optionally substituted C₁-C₁₂ alkyl thioether, an optionally substituted C₆-C₁₄ aryl thioether, an optionally substituted C₁-C₁₂ alkyl, and an optionally substituted C₆-C₁₄ aryl,
wherein any hydrogen or carbon atom can be unsubstituted or can be substituted with an epoxide, halogen, alkyl, alkoxy, perfluorinated alkyl, silyl, siloxy, silane, sulfoxide, amide, azo, ether, and thioether group, or a combination thereof.

Specific examples of epoxide functionalized organic compound according to the disclosure are 2,2,4,4-tetrafluoro-6-ethoxy-6-glycidyltricyclophosphazene, 1,1,3,5-tetrafluoro-3,5-diglycidoxycyclotriphosphazene, 1,3,5-trifluoro-1,3,5-triglycidoxycyclotriphosphazene, glycidyl pentafluorophosphazene, or a mixture thereof. These examples are only an illustration and are not meant to limit the disclosure of claims to follow.

In some embodiments, the electrolyte formulation comprises an epoxide functionalized organic compound in a concentration of from about 0.01 wt. % to about 10 wt. % of the formulation, e.g., from about 0.05 wt. % to about 8 wt. %, from about 0.1 wt. % to about 5 wt. %, from about 0.2 wt. % to about 2 wt. %, from about 0.3 wt. % to about 1 wt. %, from about 0.4 wt. % to about 0.8 wt. %, or about 0.5 wt. %.

In an embodiment of the disclosure, the electrolyte includes an aprotic organic solvent. The aprotic organic solvent comprises either ethylene carbonate, fluoroethylene carbonate, propylene carbonate, vinylene carbonate, vinyl ethyl carbonate, ethyl methyl carbonate, diethyl carbonate, dimethyl carbonate, ethyl propionate, propyl propionate, or a mixture thereof, and is present in a concentration of from about 60 wt. % to about 90 wt. % of the formulation, e.g., from about 62 wt. % to about 88 wt. %, from about 65 wt. % to about 85 wt. %, from about 68 wt. % to about 82 wt. %, from about 70 wt. % to about 80 wt. %, from about 72 wt. % to about 78 wt. %, or about 75 wt. %.

In an embodiment of the disclosure, the electrolyte includes an additive that reduces between 0.8 and 2.5V relative to lithium. In electrolyte formulations it is necessary to include sacrificial additives that will react upon the first charging of the cell to form an SEI layer on the anode, which is critical for the operation of the cell. An additive that reduces, i.e. reacts by gaining an electron, is preferred. This is because a reductive surface is formed during the initial lithiation of the anode active material that is in contact with the electrolyte.

Solvents and SEI formers, such as ethylene carbonate and fluoroethylene carbonate, reduce on the anode between approximately 2.6 and 2.8V relative to lithium. To inhibit this reduction, thus leaving more of it to continue acting as a solvent, it is preferable to have an additive reduce at a lower voltage. The nominal potential of a lithium-ion cell when assembled is below 1V, so it is preferable for the additive to only reduce when current is applied so as to prevent spontaneous reduction reactions of the solvents, as well as that of the epoxide functionalized organic compound or nitrile compounds, on the highly reducing graphite surface.

In an embodiment of the disclosure, the electrolyte additive that reduces between 0.8 and 2.5V relative to lithium is an organosulfur compound. The organosulfur compound comprises 1,3-propanesultone, 1,3-propenesultone, methylene methanedisulfonate, ethylene sulfite, ethylene sulfate, or a mixture thereof, and is present in a concentration of from about 0.1 wt. % to about 10 wt. % of the formulation, e.g., from about 0.2 wt. % to about 8 wt. %, from about 0.3 wt. % to about 6 wt. %, from about 0.5 wt. % to about 4 wt. %, from about 1 wt. % to about 3 wt. %, from about 1.5 wt. % to about 2.5 wt. %, or about 2 wt. %

In an embodiment of the disclosure, the electrolyte includes an alkyl nitrile compound. Nitrile compounds can coordinate with the Cobalt atom in the LCO cathode molecular structure. In doing so, the nitrile compounds inhibit contact between the electrolyte species and the cathode surface, preventing oxidation of the electrolyte formulation. However, nitrile compounds increase resistance because they are otherwise not conductive to lithium ions. The inclusion of nitrile molecules with epoxide functionalized organic compounds synergistically result in an optimized CEI surface, where the polymerized epoxide functionalized organic compounds conduct lithium ions.

In an embodiment of the disclosure, the electrolyte includes an alkyl nitrile compound. The alkyl nitrile compound comprises succinonitrile, valeronitrile, 1,3,6-hexanetricarbonitrile, 1,2,6-hexantetricarbonitrile, or a mixture thereof.

In some embodiments, the electrolyte formulation comprises an alkyl nitrile compound in a concentration of from about 0.1 wt. % to about 10 wt. % of the formulation, e.g., from about 0.2 wt. % to about 8 wt. %, from about 0.3 wt. % to about 6 wt. %, from about 0.5 wt. % to about 4 wt. %, from about 1 wt. % to about 3 wt. %, from about 1.5 wt. % to about 2.5 wt. %, or about 2 wt. %.

In an embodiment of the disclosure, the electrolyte includes a lithium salt. The lithium salt comprises lithium hexafluorophosphate, lithium tetrafluoroborate, lithium difluoro(oxalato)borate, lithium bis(fluorosulfonyl)imide, lithium bis(trifluoromethylsulfonyl)imide, lithium bis(oxalato)borate, lithium difluorophosphate, or a mixture thereof.

In some embodiments, anodes are disclosed for lithium-ion batteries that comprise silicon as the dominant active material. These anodes include a plurality of active material particles, a plurality of conductive carbon particles, and a conductive polymer coating around the Si active material. The active material particles include Si-composite particles, such as particles of Si-carbon composites or composites of silicon oxides with carbon.

Any suitable particle either consisting of or comprising Si can be used for the anode material described herein. In some embodiments, the silicon particles are nano or micro sized pure Si. In other embodiments, Si-composite particles include Si-carbon composite materials, such as carbon coated Si particles. In some embodiments, silicon oxides (SiOx) coated in carbon resulting in a composite are also used. The Si-composite can also be an alloy of Si with inert metals or non-metals. Other examples of Si-composite materials suitable for use in the embodiments described herein are graphene-silicon composites, graphene oxide-silicon-carbon nanotubes, silicon-polypyrroles, and composites of nano and micron sized silicon particles. As described previously, any combination of Si-composite and pure Si materials can be used in the anode material, or just a single Si-composite material can be used, preferably a Si-carbon composite.

In another embodiment of the disclosure, an electrochemical energy storage device is provided that includes a cathode, an anode and an electrolyte formulation including an epoxide functionalized organic compound as described herein. In one embodiment, the electrochemical energy storage device is a lithium secondary battery. In some embodiments, the secondary battery is a lithium battery or a lithium-ion battery.

In an embodiment, the secondary battery is provided including a positive and a negative electrode separated from each other using a porous separator and the electrolyte described herein.

Suitable cathode materials for a secondary battery including the electrolyte described herein include those such as, but not limited to carbon-coated olivine cathodes such as LiFePO₄, lithium metal oxides such as LiCoO₂, LiNiO₂, LiMn_{0.5}Ni_{0.5}O₂, Li Ni_{0.8}Mn_{0.1}Co_{0.1}O₂, Li Ni_{0.6}Mn_{0.2}Co_{0.2}O₂, LiNi_{0.5}Mn_{0.3}Co_{0.2}O₂, Li Ni_{0.33}Mn_{0.33}Co_{0.33}O₂, LiMn₂O₄, LiFePO₄, and LiNiₓCo_{y}Mn_{z}O₂ wherein x, y and z sum to 1, or a mixture thereof.

In an embodiment, the cathode material comprises LiCoO₂, and the cut-off voltage of the secondary battery is at least 4.4 V. As discussed above, to achieve a significant proportion of the secondary cell's capacity requires charging the full cell above conventional cut-off voltages to at least 4.45 V. Conventional electrolyte formulations will begin to oxidize and degrade at this cut-off voltage, thus making the use of LCO cathode challenging and undesirable.

In some embodiments, the cut-off voltage is at least 4.40 V, at least 4.41 V, at least 4.42 V, at least 4.43 V, at least 4.44 V, at least 4.45 V, at least 4.46 V, at least 4.47 V, at least 4.48 V, at least 4.49 V, at least 4.50 V, at least 4.55 V, at least 4.60 V, at least 4.65 V, at least 4.70 V, at least 4.75 V, at least 4.80 V, at least 4.85 V, at least 4.90 V, at least 4.95 V, or at least 5.00 V.

Suitable anodes include, e.g., lithium metal, graphitic material, amorphous carbon, Li₄Ti₅O₁₂, tin alloy, silicon, silicon oxide, silicon alloy, silicon-carbon composite, or a mixture thereof. Suitable graphitic materials (Gr) include natural graphite, artificial graphite, graphitized meso-carbon microbeads (MCMB), graphite fibers, as well as any amorphous carbon materials. In some embodiments, the anode and cathode electrodes are separated from each other by a porous separator.

In some embodiments, the anode is a composite anode including active materials such as silicon and silicon alloys, and a conductive polymer coating around the active material. The active material may be in the form of silicon particles having a particle size of between about 1 nm and about 100 μm. Other suitable active materials include but are not limited to hard-carbon, graphite, tin, and germanium particles. The polymer coating material can be cyclized using heat treatment at temperatures of from 200° C. to 400° C. to thereby convert the polymer to a ladder compound by crosslinking polymer chains. Specific polymers that can be used include but are not limited to polyacrylonitrile (PAN) where the cyclization changes the nitrile bond (C≡N) to a double bond (C≡N). The polymer material forms elastic but robust films to allow for controlled fragmentation/pulverization of silicon particles within the polymer matrix. Additionally, the PAN matrix also provides a path for Li-ion mobility thus enhancing the conductivity of the composite anode. The resultant anode material can overcome expansion and conductivity challenges of silicon-based anodes, such as by providing binders that can prevent expansion of silicon particles and conductive additives to provide a path for Li-ion mobility. In some embodiments, the polymer is about 10 wt. % to 40 wt. % of the anode composite material. Additional description of these Si-PAN composite anodes is provided in U.S. Pat. Nos. 10,573,884 and 10,707,481, both of which are hereby incorporated by reference in their entirety.

The separator for the lithium battery may be a microporous polymer film. Examples of polymers for forming films include polypropylene, polyethylene, nylon, cellulose, nitrocellulose, polysulfone, polyacrylonitrile, polyvinylidene fluoride, polybutene, copolymers, or combinations of any two or more of such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

In some embodiments, the electrolyte formulation is designed for high-voltage lithium-ion cells and comprises a combination of epoxide functionalized organic compounds and fluorinated ethyl acetate co-solvents. This formulation enables operation at voltages of 4.30 V or higher for nickel-manganese-cobalt (NMC) cathodes and 4.47 V or higher for lithium cobalt oxide (LCO) cathodes. The synergistic interaction between the epoxide additive and the fluorinated ester provides oxidative stability and reduces impedance growth, while forming a robust cathode electrolyte interface (CEI) that enhances cycle life and high-temperature performance. These features collectively allow for safe, efficient, and long-term cycling of high-energy lithium-ion batteries in demanding applications.

In some embodiments, the electrolyte formulation further comprises a fluorinated aliphatic ester compound. The fluorinated aliphatic ester may include 2,2-difluoroethyl acetate, 2,2,2-trifluoroethyl acetate, 2-fluoroethyl acetate, or a mixture thereof. The fluorinated aliphatic ester is present in a concentration of from about 10 wt. % to about 80 wt. % of the electrolyte formulation.

In some embodiments, the electrolyte formulation comprises a fluorinated aliphatic ester in a concentration of from about 10 wt. % to about 80 wt. % of the formulation, e.g., from about 20 wt. % to about 75 wt. %, from about 30 wt. % to about 70 wt. %, from about 35 wt. % to about 65 wt. %, from about 40 wt. % to about 60 wt. %, from about 50 wt. % to about 60 wt. %, or about 60 wt. %.

In some embodiments, the fluorinated aliphatic ester provides enhanced oxidative stability due to the presence of C—F bonds, which are less susceptible to oxidation at high voltages compared to conventional carbonic acid esters. This oxidative stability enables long-term operation of high-voltage lithium-ion cells while maintaining compatibility with lithium salts.

In some embodiments, the inclusion of fluorinated aliphatic ester in combination with an epoxide functionalized organic compound synergistically reduces cell resistance. The epoxide functionalized organic compound forms a cathode electrolyte interface (CEI) that mitigates impedance growth associated with the high viscosity of fluorinated esters, thereby improving fast-charging capability and cycle life.

In some embodiments, the aprotic organic solvent is present in a concentration of from about 30 wt. % to about 60 wt. % of the electrolyte formulation. This range differs from conventional formulations that utilize higher solvent concentrations, and is optimized to accommodate the presence of fluorinated aliphatic ester while maintaining ionic conductivity.

In some embodiments, the electrolyte formulation is suitable for use in electrochemical energy storage devices comprising high-voltage cathode materials such as lithium cobalt oxide (LiCoO₂) with a cut-off voltage of at least 4.47 V, or nickel-manganese-cobalt oxide (NMC) cathodes with a cut-off voltage of at least 4.30 V. These voltage thresholds enable improved energy density relative to conventional lithium-ion cells.

In some embodiments, the electrolyte formulation comprises an organosulfur compound in a concentration of from about 0.1 wt. % to about 10 wt. % of the formulation. Suitable organosulfur compounds include 1,3-propanesultone, 1,3-propenesultone, methylene methanedisulfonate, ethylene sulfite, ethylene sulfate, 1,3,6,9,12-pentaoxa-2-thiacyclotetradecane-2,2-dioxide, or a mixture thereof.

In some embodiments, the electrolyte formulation comprises an organosulfur compound in a concentration of from about 0.1 wt. % to about 10 wt. % of the formulation, e.g., from about 0.2 wt. % to about 8 wt. %, from about 0.3 wt. % to about 6 wt. %, from about 0.5 wt. % to about 4 wt. %, from about 1 wt. % to about 3 wt. %, from about 1.5 wt. % to about 2.5 wt. %, or about 2 wt. %.

In some embodiments, the synergistic combination of fluorinated ethyl acetate and epoxide functionalized organic compounds enables the formation of a stable CEI layer on the cathode surface, which reduces oxidative side reactions and gas generation during high-temperature storage. This results in improved dimensional stability, lower impedance growth, and enhanced capacity retention over extended cycling.

In some embodiments, the electrolyte formulation is configured for use in lithium-ion cells that include NMC cathodes paired with graphite anodes, enabling operation at voltages of 4.30 V or higher. The formulation reduces impedance growth associated with high-viscosity fluorinated esters and improves coulombic efficiency during extended cycle life testing.

In some embodiments, the electrolyte formulation can provide enhanced safety for high-energy lithium-ion batteries by incorporating flame-retardant and thermal-stability additives alongside cathode-stabilizing components. The combination of partially fluorinated phenyl phosphate esters, fluorinated cyclic phosphazenes, and epoxide functionalized organic compounds synergistically reduces the risk of thermal runaway under abuse conditions while maintaining high energy density and long cycle life. These formulations enable safer operation of lithium-ion cells in demanding applications such as electric vehicles and grid storage.

In some embodiments, the electrolyte formulation comprises a cyclic carbonate, an aprotic organic solvent, a partially fluorinated phenyl phosphate ester, a fluorinated cyclic phosphazene, an organosulfur compound, a lithium salt, and an epoxide functionalized organic compound. This multi-component system is designed to enhance safety and thermal stability while maintaining high energy density.

In some embodiments, the electrolyte formulation includes cyclic carbonates such as ethylene carbonate, fluoroethylene carbonate, propylene carbonate, vinylene carbonate, or a mixture thereof. The cyclic carbonates may be present in a concentration of from about 15 wt. % to about 30 wt. % of the formulation, e.g., from about 16 wt. % to about 28 wt. %, from about 17 wt. % to about 27 wt. %, from about 18 wt. % to about 26 wt. %, from about 19 wt. % to about 25 wt. %, from about 20 wt. % to about 24 wt. %, or about 22 wt. %.

In some embodiments, the electrolyte formulation includes an aprotic organic solvent comprising ethyl methyl carbonate, diethyl carbonate, dimethyl carbonate, ethyl propionate, propyl propionate, or a mixture thereof. The aprotic organic solvent may be present in a concentration of from about 30 wt. % to about 70 wt. % of the formulation, e.g., from about 32 wt. % to about 68 wt. %, from about 35 wt. % to about 65 wt. %, from about 38 wt. % to about 62 wt. %, from about 40 wt. % to about 60 wt. %, from about 42 wt. % to about 58 wt. %, or about 45 wt. %.

In some embodiments, the electrolyte formulation includes a partially fluorinated phenyl phosphate ester. Suitable examples include 4-fluorophenyl diphenylphosphate and 3,5-difluorophenyl diphenylphosphate. The partially fluorinated phenyl phosphate ester may be present in a concentration of about 0.5 wt. % to about 15 wt. % of the formulation.

In some embodiments, the electrolyte formulation includes a fluorinated cyclic phosphazene. Suitable examples include ethoxy(pentafluoro)cyclotriphosphazene and phenoxy(pentafluoro)cyclotriphosphazene. The fluorinated cyclic phosphazene may be present in a concentration of about 1.0 wt. % to about 10 wt. % of the formulation.

In some embodiments, the electrolyte formulation includes an organosulfur compound. Suitable examples include 1,3-propanesultone, 1,3-propenesultone, methylene methanedisulfonate, ethylene sulfite, ethylene sulfate, 1,3,6,9,12-pentaoxa-2-thiacyclotetradecane-2,2-dioxide, sulfolane, or a mixture thereof. The organosulfur compound may be present in a concentration of about 1.0 wt. % to about 10 wt. % of the formulation.

In some embodiments, the electrolyte formulation includes a lithium salt. Suitable examples include lithium hexafluorophosphate, lithium tetrafluoroborate, lithium difluoro(oxalato)borate, lithium bis(fluorosulfonyl)imide, lithium bis(trifluoromethylsulfonyl)imide, lithium bis(oxalato)borate, lithium tetrafluoro(oxalato)phosphate, lithium difluorophosphate, or a mixture thereof.

The lithium salt may be present in a concentration of about 10 wt. % to about 30 wt. % of the formulation, e.g., from about 12 wt. % to about 28 wt. %, from about 15 wt. % to about 25 wt. %, from about 16 wt. % to about 24 wt. %, from about 18 wt. % to about 22 wt. %, from about 19 wt. % to about 21 wt. %, or about 20 wt. %.

In some embodiments, the electrolyte formulation can provide improved abuse tolerance and thermal stability. The combination of fluorinated cyclic phosphazene and partially fluorinated phenyl phosphate ester acts as a flame-retardant system that delays thermal runaway under high-temperature conditions.

In some embodiments, the electrolyte formulation is suitable for high-energy lithium-ion batteries having a measured specific energy density of at least 240 Wh/kg, e.g., at least 245 Wh/kg, at least 250 Wh/kg, at least 255 Wh/kg, at least 260 Wh/kg, at least 265 Wh/kg, at least 270 Wh/kg, at least 275 Wh/kg, at least 280 Wh/kg, at least 285 Wh/kg, or at least 290 Wh/kg; and/or a measured volumetric energy density of at least 600 Wh/L, e.g., at least 610 Wh/L, at least 620 Wh/L, at least 630 Wh/L, at least 640 Wh/L, at least 650 Wh/L, at least 660 Wh/L, at least 670 Wh/L, at least 680 Wh/L, at least 690 Wh/L, or at least 700 Wh/L.

In some embodiments, the cathode comprises nickel-rich layered oxides such as LiNiO₂, LiNi_{0.8}Mn_{0.1}Co_{0.1}O₂, LiNi_{0.90}Mn_{0.05}Co_{0.05}O₂, or other NMC compositions, and the electrolyte formulation provides enhanced cycle life and safety for these high-energy cathodes.

In some embodiments, the synergy among the epoxide functionalized organic compound, fluorinated cyclic phosphazene, and partially fluorinated phenyl phosphate ester enables formation of a robust cathode electrolyte interface (CEI) that reduces impedance growth and mitigates oxidative side reactions, while simultaneously imparting flame-retardant properties to the electrolyte.

In some embodiment, the energy storage device comprising the disclosed electrolyte formulation demonstrates greater than 85% capacity retention after 150 cycles, greater than 95% capacity retention after 800 cycles.

In some embodiment, the energy storage device comprising the disclosed electrolyte formulation demonstrates greater than 98.4% capacity retention after 250 cycles, greater than 76.5% capacity retention after 600 cycles.

In some embodiment, the energy storage device comprising the disclosed electrolyte formulation demonstrates greater than 94% capacity retention after 300 cycles, greater than 76% capacity retention after 300 cycles.

In some embodiment, the energy storage device comprising the disclosed electrolyte formulation demonstrates greater than 87.5% capacity retention after 60 cycles.

In some embodiments, a formulation comprises an aprotic organic solvent, a lithium salt, a fluorinated aliphatic ester, and an epoxide functionalized organic compound represented by formula (I):

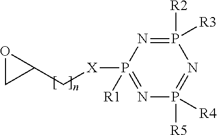

(I), wherein n is an integer from 1 to 8; X is oxygen or sulfur; and R1, R2, R3, R4, and R5 are independently selected from a halogen atom, an optionally substituted C1-C12 alkyl ether, an optionally substituted C6-C14 aryl ether, an optionally substituted C1-C12 alkyl thioether, an optionally substituted C6-C14 aryl thioether, an optionally substituted C1-C12 alkyl, and an optionally substituted C6-C14 aryl, wherein any hydrogen or carbon atom can be unsubstituted or substituted with an epoxide, halogen, alkyl, alkoxy, perfluorinated alkyl, silyl, siloxy, silane, sulfoxide, amide, azo, ether, and thioether group, or a combination thereof.

In some embodiments, the fluorinated aliphatic ester comprises 2,2-difluoroethyl acetate, 2,2,2-trifluoroethyl acetate, 2-fluoroethyl acetate, or a mixture thereof.

In some embodiments, an electrolyte formulation comprises at least two cyclic carbonates, an aprotic organic solvent, a partially fluorinated phenyl phosphate ester, a fluorinated cyclic phosphazene, at least two organosulfur compounds, at least two lithium salts, and an epoxide functionalized organic compound represented by formula (I):

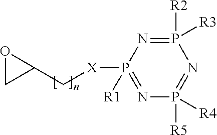

(I), wherein n is an integer from 1 to 8; X is oxygen or sulfur; and R1, R2, R3, R4, and R5 are independently selected from a halogen atom, an optionally substituted C1-C12 alkyl ether, an optionally substituted C6-C14 aryl ether, an optionally substituted C1-C12 alkyl thioether, an optionally substituted C6-C14 aryl thioether, an optionally substituted C1-C12 alkyl, and an optionally substituted C6-C14 aryl, wherein any hydrogen or carbon atom can be unsubstituted or substituted with an epoxide, halogen, alkyl, alkoxy, perfluorinated alkyl, silyl, siloxy, silane, sulfoxide, amide, azo, ether, and thioether group, or a combination thereof.

In some embodiments, the partially fluorinated phenyl phosphate ester comprises 4-fluorophenyl diphenylphosphate, 3,5-difluorophenyl diphenylphosphate, or a mixture thereof.

In some embodiments, the fluorinated cyclic phosphazene comprises ethoxy(pentafluoro)cyclotriphosphazene, phenoxy(pentafluoro)cyclotriphosphazene, or a mixture thereof.

### EXAMPLES

The disclosure will be further illustrated with reference to the following specific examples. It is understood that these examples are given by way of illustration and are not meant to limit the disclosure or the claims to follow.

### Example 1—Electrolytes for LCO/Gr Cells

Electrolyte formulations were prepared in a dry argon filled glovebox by combining all the electrolyte components in a glass vial and stirring for 24 hours to ensure a completely homogeneous mixture. The individual components of the electrolyte formulations are ethylene carbonate (EC), propylene carbonate (PC), ethyl propionate (EP), propyl propionate (PP), fluoroethylene carbonate (FEC), 1,3-propanesultone (PaS), 1,3-propenesultone (PeS), 1,3,6-hexacarbonitrile (HTCN), lithium hexafluorophosphate (LiPF₆), lithium bis(fluorosulfonyl)imide (LiFSI), and 2,2,4,4-tetrafluoro-6-ethoxy-6-glycidyltricyclophosphazene (EFOC). The base formulation for all formulations tested was 1M LiPF₆ in EC/EP/PP 30/25/45 weight basis solvent. On a weight basis relative to the entire formulation 2% PaS, 0.3% PeS, 7% FEC, and 3% HTCN were included in the electrolyte formulation. The Embodiment Examples use the representative example molecule EFOC at a concentration of 0.5 wt. % and is readily miscible in the solution. LiFSI is added as an electrolyte additive to reduce cell resistance. The electrolyte formulations are summarized in Table A.

TABLE A
Electrolyte Formulations

| Electrolyte | Additive |
|---|---|
| Comparative Example 1 (CE1) | None |
| Comparative Example 2 (CE2) | 3 wt % LiFSI |
| Embodiment Example 1 (EE1) | 0.5 wt % EFOC |
| Embodiment Example 2 (EE2) | 3 wt % LiFSI; 0.5 wt % EFOC |

### Example 2—LCO/Graphite Cell Data

The electrolyte formulations prepared are used as electrolytes in 230 mAh Li-ion pouch cells comprising lithium cobalt oxide (LCO) cathode active material and artificial graphite as the anode active material. A conventional polyethylene film is used as a separator. In each cell, 0.9 mL of electrolyte formulation was added and allowed to soak in the cell for 1 hour. The cells are vacuum sealed, and primary charged before wetting at 25° C. for 10 hours. The cells were then charged to 3.8 V at C/10 rate at 60° C. before degassing, followed by vacuum sealing. The EFOC is activated during this step. After degassing, the cells were charged and discharged twice from 4.45 V to 3.0 V at C/10 rate at 25° C. The direct current internal resistance (DCIR) is then collected by applying a 10 second 1C discharge pulse to the cell and measuring the voltage drop of the cell, this is done at 50% state-of-charge (SOC). The results are summarized in Table B. With addition of 0.5 wt. % EFOC, the initial cell data is comparable to reference electrolyte, and the nominal capacity of the cells is achieved.

It is also observed that while the other parameters such as the Formation Discharge Capacity and the 1^{st} Coulombic Efficiency are not compromised, the incorporation of EFOC beneficially reduces the resistance of the Embodiment Example cell relative to the Comparative Example.

For instance, the DCIR of the Embodiment Examples are at least 11% to 22% lower than the Comparative Examples that do not include the claimed electrolyte formulation. A lower DCIR generally signifies a cell's capability to deliver power efficiently and effectively. For example a lower DCIR implies improved current handling, which means the cell can handle higher discharge currents more effectively, and is crucial for applications requiring rapid bursts of power, such as in electric vehicles or aircraft; higher efficiency, whereas less energy is lost as heat during charging and discharging; better voltage stability: a lower internal resistance contributes to more stable voltage output under load, meaning the cell can maintain its voltage better during high current draws, which is essential for consistent performance.

TABLE B
Initial Cell Data for LCO/Graphite cells

| | 1^{st} Coulombic | Formation | DCIR (10 s 1 C |
|---|---|---|---|
| | Efficiency | Discharge Capacity | Discharge) |
| Electrolyte | (%) | (mAh) | (mΩ) |
| CE1 | 92.7 | 238.1 | 618 |
| CE2 | 92.6 | 237.2 | 570 |
| EE1 | 92.7 | 239.5 | 480 |
| EE2 | 92.7 | 239.2 | 507 |

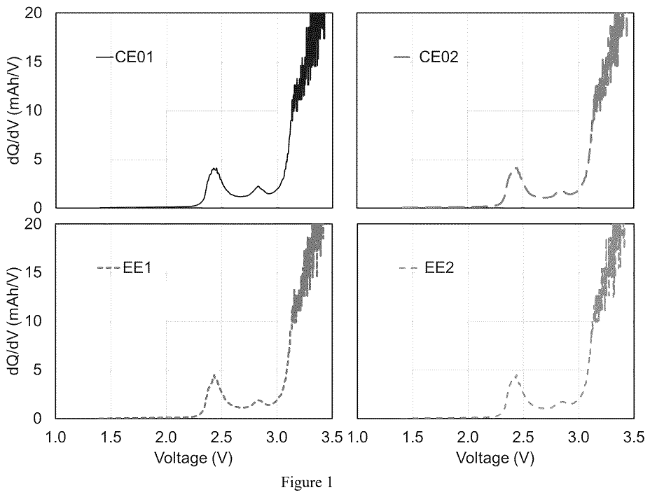

The initial charge profile of formation is shown as a derivative of the capacity relative to potential for the four electrolytes (CE1, CE2, EE1, and EE2) in FIG. 1. A peak in the profile, which is a change in capacity at a given potential, is indicative of a reduction reaction attributable to components in the electrolyte formulations. The height of the peaks is correlated to the overall concentration of component that is reduced, i.e., a higher peak means more of that component is being reduced. The change in capacity is due to the nucleophilic attack on the components in the electrolyte formulations—and in this instance the organosulfur additives. It is observed that the electrolytes tested all demonstrate a peak at approximately 2.4V, due to the reduction of the organosulfur additives at potentials below 2.5V.

The additional smaller peak at 2.8V is attributable to FEC, which indicates that only a small amount of FEC is reduced relative to the organosulfur compounds, despite that FEC has a much higher concentration in the overall electrolyte formulation. This significantly lower amount of FEC reduction is beneficial, because it reduces side reactions, leading to a more stable electrochemical environment. It also helps to maintain a thinner, more effective SEI, enhancing ion transport, reducing internal resistance, and improving cycle life of the cell.

After the activation and formation procedure the cells are subjected to a rate test. The cells are all discharged at 0.5 C constant current rate to 0% SOC, followed by a constant current charge rate of 2C to 4.45 V. This procedure is repeated with the subsequent constant current charge rate increasing to 3C. The results are summarized in Table C. The Embodiment Examples all demonstrate higher charge capacity relative to the Comparative Examples, this is a function of the lower resistance with the EFOC. Further, a higher potential is observed at a given state-of-charge for the comparative examples relative to the embodiment examples. This is also indicative of the reduced resistance provided by the inclusion of EFOC.

TABLE C
Fast Charge data for LCO/Graphite cells

| | 2 C Constant | 3 C Constant | Potential at 50% |
|---|---|---|---|
| | Current Charge | Current Charge | SOC at 3 C Constant |
| Electrolyte | (mAh) | (mAh) | Current Charge (V) |
| CE1 | 175.8 | 150.8 | 4.33 |
| CE2 | 185.0 | 148.1 | 4.36 |
| EE1 | 183.9 | 151.6 | 4.32 |
| EE2 | 185.0 | 170.7 | 4.26 |

After the activation and formation procedure the cells are subjected to a high temperature storage test. The cells are charged to 100% SOC at 4.45 V at a 0.3C rate and then the thickness of the cell is measured at the center of the active stack. The alternating current internal resistance (AC-IR) is measured at 100% SOC with a Hioki battery impedance meter. The cells are then stored in a 60° C. environmental chamber for three weeks. After three weeks, the change in thickness, resistance and capacity of the cells was measured. The results are summarized in Table D.

As is shown in Table D, using the electrolyte formulation described herein beneficially improve the following performances: less cell thickness growth, lower initial IR, lower IR growth at 3 weeks, higher initial capacity, and higher capacity at 3 weeks. These improved performances are significant in the following ways: less cell thickness growth suggests that the Embodiment Examples have better structural integrity and less degradation over time, which is crucial for longevity; lower initial IR means the cell can deliver power more efficiently, enhancing performance; lower IR growth at 3 weeks indicates stability in performance over time, which is essential for reliable operation; higher initial capacity means the cell can store more energy, improving its overall utility; and higher capacity at 3 weeks indicates a strong sign of durability and effective cycling. The use of the described electrolyte formulation unexpectedly achieves all of the above features at the same time.

Specifically, gas generation at elevated temperature is mainly due to the accelerated decomposition of the cathode material interacting with the electrolyte, which detrimentally results in increased resistance (IR) and lower capacity. The incorporation of the epoxide functionalized organic compound additive, EFOC, unexpectedly results in significantly reduced gas generation and resistance growth relative to the comparative example.

TABLE D
60° C. Storage data for LCO/Gr cells

| | Initial | % | | | | % |
|---|---|---|---|---|---|---|
| | Cell | Thickness | Initial | % IR | Initial | Capacity |
| | thickness | growth at | Cell AC- | growth at | Capacity | at 3 |
| Electrolyte | (mm) | 3 weeks | IR (mΩ) | 3 weeks | (mAh) | weeks |
| CE1 | 4.10 | 2.25 | 120.4 | 137.3 | 226.3 | 52.0 |
| CE2 | 4.10 | 1.99 | 121.0 | 137.8 | 228.5 | 55.5 |
| EE1 | 4.09 | 1.81 | 118.0 | 134.6 | 231.3 | 60.7 |
| EE2 | 4.05 | 0.99 | 120.0 | 119.0 | 230.4 | 63.6 |

### Example 3—Electrolytes for LCO/Graphite Cells with FEC

Electrolyte formulations were prepared in a dry argon filled glovebox by combining all the electrolyte components in a glass vial and stirring for 24 hours to ensure a completely homogeneous mixture. The individual components of the electrolyte formulations are fluoroethylene carbonate (FEC), propylene carbonate (PC), ethyl methyl carbonate (EMC), 2,2-difluoroethyl acetate (DFEA), 1,3-propanesultone (PaS), 1,3-propenesultone (PeS), 1,3,6-hexacarbonitrile (HTCN), lithium hexafluorophosphate (LiPF6), and 2,2,4,4-tetrafluoro-6-ethoxy-6-glycidyltricyclophosphazene (EFOC). The base salt concentration for all formulations tested was 1.2M LiPF6, and all formulations contained 1.5 wt % of HTCN AND 10 wt % of FEC. The Embodiment Example (EE3) use the representative example molecule EFOC as per the present disclosure at a concentration of 0.5 weight percent and is readily miscible in the solution The electrolyte components and additives used in are summarized in Table E.

TABLE E
Electrolyte Formulations for Li-ion cells

| Electrolyte | Solvent | Additive |
|---|---|---|
| Comparative Example 3 | 30:70 PC:EMC | None |
| (CE3) | | |
| Comparative Example 4 | 30:70 PC:DFEA | None |
| (CE4) | | |
| Embodiment Example 3 | 30:70 PC:DFEA | 0.5 wt % EFOC |
| (EE3) | | |

### Example 4—LCO/Graphite Cell Data

The electrolyte formulations prepared are used as electrolytes in 230 mAh Li-ion pouch cells comprising lithium cobalt oxide (LCO) cathode active material and artificial graphite as the anode active material. A conventional polyethylene film is used as a separator. In each cell, 0.9 mL of electrolyte formulation was added and allowed to soak in the cell for 1 hour. The cells are vacuum sealed, and primary charged before wetting at 25° C. for 10 hours. The cells were then charged to 3.8 V at C/10 rate at 25° C. before degassing, followed by vacuum sealing. After degassing, the cells were charged and discharged twice between 4.47 V and 3.0 V at C/10 rate at 25° C. The direct current internal resistance (DCIR) is then collected by applying a 10 second 1C discharge pulse to the cell and measuring the voltage drop of the cell, this is done at 50% state-of-charge (SOC). The results are summarized in Table F. With addition of 0.5 wt. % EFOC, the initial cell data is comparable to reference electrolyte, and the nominal capacity of the cells is achieved. Furthermore, the incorporation of EFOC beneficially reduces the resistance of the cell relative to the Comparative Examples.

TABLE F
Initial Cell Data for LCO/Graphite cells

| | | Formation | DCIR |
|---|---|---|---|
| | 1^{st} Coulombic | Discharge | (10 s 1 C |
| | Efficiency | Capacity | Discharge) |
| Electrolyte | (%) | (mAh) | (mΩ) |
| CE3 | 92.8 | 238.4 | 674.1 |
| CE4 | 93.0 | 239.0 | 567.2 |
| EE3 | 92.8 | 238.8 | 509.2 |

After the activation and formation procedure the cells are subjected to a rate test. The cells are all discharged at 0.5C constant current rate to 0% SOC, followed by a constant current charge rate of 2C to 4.47V. This procedure is repeated with the subsequent constant current charge rate increasing to 3C. The results are summarized in Table G. Both CE4 and EE3 examples demonstrate higher charge capacity relative to the CE3, which is due to the function of the greater oxidation stability of DFEA. However, the action at the cathode itself for EFOC allows EE3 to surpass CE4. Further, a higher potential is observed at a given state-of-charge for the Comparative Examples relative to the Embodiment Example. This is also indicative of the reduced resistance provided by the inclusion of EFOC.

TABLE G
Fast Charge data for LCO/Graphite cells

| | | | Potential at 50% |
|---|---|---|---|
| | 2 C Constant | 3 C Constant | SOC at 3 C Constant |
| | Current Charge | Current Charge | Current Charge |
| Electrolyte | (mAh) | (mAh) | (V) |
| CE3 | 171.3 | 150.9 | 4.35 |
| CE4 | 183.2 | 165.0 | 4.26 |
| EE3 | 187.2 | 172.0 | 4.21 |

After the activation and formation procedure the cells are subjected to a high temperature storage test. The cells are charged to 100% SOC at 4.47 V at a 0.3C rate and then the thickness of the cell is measured at the center of the active stack. The alternating current internal resistance (AC-IR) is measured at 100% SOC with a Hioki battery impedance meter. The cells are then stored in a 60° C. environmental chamber for three weeks. After three weeks, the change in thickness, resistance and capacity of the cells was measured. The results are summarized in Table H. As can be seen in Table H, all cells demonstrated some swelling attributable to gas generation, increase in resistance, and loss of capacity. Gas generation at elevated temperature is largely a function of the accelerated decomposition of the cathode material interacting with the electrolyte, also resulting in increased resistance and lower capacity. The inclusion of DFEA greatly reduces this inferior performance, because its fluorine content in the bulk of the electrolyte provides for resistance to oxidative and thermal decomposition. Synergistically, the incorporation of the epoxide functionalized organic compound, EFOC, results in significantly reduced gas generation and resistance growth relative to the Comparative Example. EFOC is thus shown to greatly inhibit these reactions as shown in Table H.

TABLE H
60° C. Storage data for LCO/Graphite cells

| | Initial | % | | | | % |
|---|---|---|---|---|---|---|
| | Cell | Thickness | Initial | % IR | Initial | Capacity |
| | thickness | growth at | Cell AC- | growth at | Capacity | at 3 |
| Electrolyte | (mm) | 3 weeks | IR (mΩ) | 3 weeks | (mAh) | weeks |
| CE3 | 4.1 | 7.6 | 122.0 | 103.3 | 233.7 | 84.0 |
| CE4 | 4.0 | 5.4 | 127.3 | 98.4 | 236.1 | 81.0 |
| EE3 | 4.1 | 4.9 | 121.4 | 90.3 | 239.9 | 83.0 |

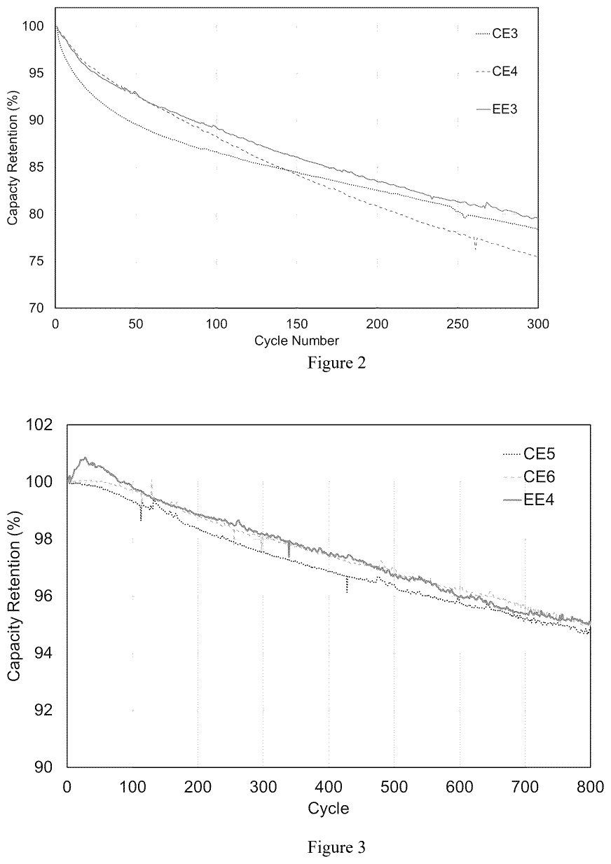

After the activation and formation procedure the cells are subjected to a cycle life test. The cells are then charged and discharged 300 times between 4.47V to 3.0 V at 1.0 C charge and discharge rate at 25° C. The relative discharge capacity versus cycle count is displayed in FIG. 2 and summarized in Table I.

TABLE I
Capacity Retention data for LCO/Gr cells

| | Capacity Retention | Capacity Retention |
|---|---|---|
| Electrolyte | after 150 Cycles (%) | after 300 Cycles (%) |
| CE3 | 84.1 | 78.4 |
| CE4 | 84.0 | 75.4 |
| EE3 | 86.0 | 79.5 |

The cycle life characteristics as shown in FIG. 2 and Table I show that EE3 outperforms both the Comparative Examples for about 300 cycles through improved capacity retention. The high viscosity of DFEA over EMC causes impedance growth over cycles in spite of its high oxidative stability. However, the formation of a superior CEI with EFOC allows for a cell to lose less capacity to oxidative side-reactions and thus retain capacity better relative to the Comparative Examples.

### Example 5—Electrolytes for NMC/Graphite Cells

Electrolyte formulations were prepared in a dry argon filled glovebox by combining all the electrolyte components in a glass vial and stirring for 24 hours to ensure a completely homogeneous mixture. The individual components of the electrolyte formulations are FEC, ethylene carbonate (EC), EMC, DFEA, PaS, lithium difluorophosphate (LFO), LiPF6, and EFOC. The base salt concentration for all formulations tested was 1.0M LiPF6, and all formulations contained 1.0 wt % of PaS, 10 wt % of FEC, and 1 wt % of LFO. The Embodiment Examples (EE4) use the representative example molecule EFOC as per the present disclosure at a concentration of 0.5 weight percent and is readily miscible in the solution. The electrolyte components and additives used in are summarized in Table J.

TABLE J
Electrolyte Formulations for Li-ion cells

| Electrolyte | Solvent | Additive |
|---|---|---|
| Comparative Example 5 | 30:70 EC:EMC | None |
| (CE5) | | |
| Comparative Example 6 | 30:70 EC:EMC | 0.5 wt % EFOC |
| (CE6) | | |
| Embodiment Example 4 | 30:70 EC:DFEA | 0.5 wt % EFOC |
| (EE4) | | |

### Example 6—NMC/Graphite Cell Data

The electrolyte formulations prepared are used as electrolytes in 240 mAh Li-ion pouch cells comprising NMC811 (NMC) cathode active material and artificial graphite as the anode active material. A polyethylene film is used as a separator. In each cell, 0.9 mL of electrolyte formulation was added and allowed to soak in the cell for 1 hour. The cells are vacuum sealed, and primary charged before wetting at 25° C. for 10 hours. The cells were then charged to 3.8 V at C/10 rate at 25° C. before degassing, followed by vacuum sealing. After degassing, the cells were charged and discharged twice between 4.30 and 3.0 V at C/10 rate at 25° C. The alternating current internal resistance (AC-IR) is measured at 100% SOC with a Hioki battery impedance meter. The results are summarized in Table K. With the replacement of EMC with DFEA in conjunction with EFOC, the initial cell data is comparable to reference electrolyte and the nominal capacity of the cells is achieved. The incorporation of EFOC paired with DFEA synergistically reduces the resistance of the cell relative to the Comparative Examples.

TABLE K
Initial Cell Data for NMC/Graphite cells

| | 1^{st} Coulombic | Formation | Initial Cell |
|---|---|---|---|
| | Efficiency | Discharge Capacity | AC-IR |
| Electrolyte | (%) | (mAh) | (mΩ) |
| CE5 | 86.8 | 250.8 | 114.4 |
| CE6 | 86.4 | 249.9 | 120.4 |
| EE4 | 86.9 | 251.7 | 103.7 |

After the activation and formation procedure, the cells are subjected to a cycle life test. The cells are then charged and discharged 500 times between 4.30V to 3.0 V at 1.0 C charge and discharge rate at 25° C. The relative discharge capacity versus cycle count is displayed in FIG. 3 and summarized in Table L.

TABLE L
Capacity Retention data for NMC/Gr cells

| | Capacity | Coulombic | Capacity | Coulombic |
|---|---|---|---|---|
| | Retention | Efficiency | Retention | Efficiency |
| | after 250 | after 250 | after 800 | after 800 |
| | Cycles | cycles | Cycles | cycles |
| Electrolyte | (%) | (%) | (%) | (%) |
| CE5 | 97.8 | 99.8 | 94.9 | 99.8 |
| CE6 | 98.4 | 99.8 | 94.9 | 99.8 |
| EE4 | 98.5 | 99.9 | 95.1 | 99.9 |

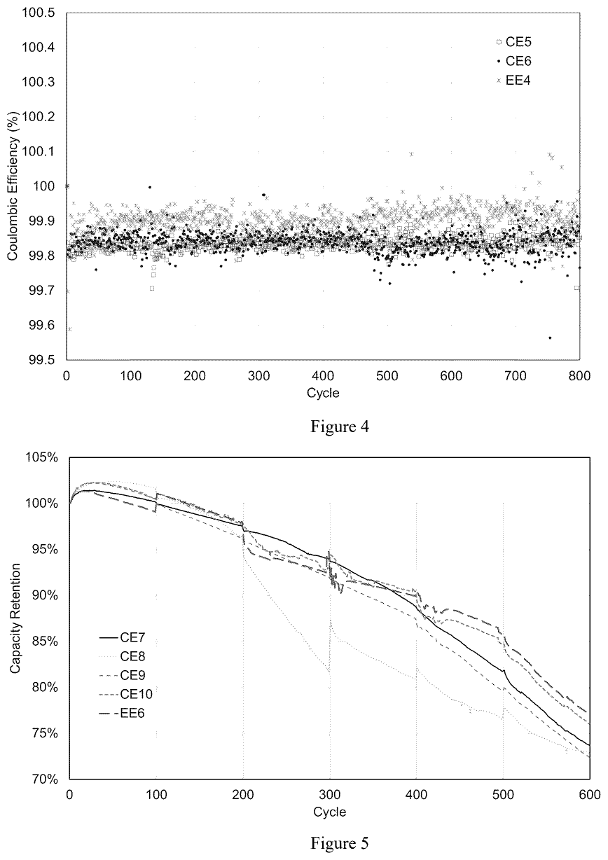

The cycle life characteristics as shown in FIG. 3 and Table L show that EE4 outperforms both the Comparative Examples for about 800 cycles through improved capacity retention. The high viscosity of DFEA over EMC causes impedance growth over cycles in spite of its high oxidative stability. The formation of a superior CEI with EFOC allows for a cell to lose less capacity to oxidative side-reactions, and thus retain capacity better relative to the Comparative Examples. In FIG. 4 this is further exemplified with the greater coulombic efficiency of EE4.

### Example 7—Electrolytes for NMC/Graphite Cells

Electrolyte formulations were prepared in a dry argon filled glovebox by combining all the electrolyte components in a glass vial and stirring for 24 hours to ensure a completely homogeneous mixture. The individual components of the electrolyte formulations are fluoroethylene carbonate (FEC), ethylene carbonate (EC), ethyl methyl carbonate (EMC), ethoxy(pentafluoro)cyclotriphosphazene (PFPN), 1,3-propanesultone (PaS), 1,3-propenesultone (PeS), ethylene sulfate (ESA), vinylene carbonate (VC), lithium difluorophosphate (LFO), lithium bis(fluorosulfonyl)imide (LiFSI), lithium hexafluorophosphate (LiPF₆), 4-fluorophenyl diphenyl phosphate (TPPF), and 2,2,4,4-tetrafluoro-6-ethoxy-6-glycidyltricyclophosphazene (EFOC). The weight of EC:EMC in all electrolyte formulations tested was EC:EMC=1:3. All formulations also contained 1.0 wt % of LFO, 0.5 wt % of VC, 1 wt % of FEC, 0.5 wt % of PS, 0.3% PeS, and 0.5% of ESA. LiFSI is an electrolyte additive for reducing cell resistance and is evaluated as well. The Embodiment Examples use the representative example molecule EFOC as per the present application at a concentration of 0.5 wt. % and is readily miscible in the formulation. The components of the electrolyte formulations used are summarized in Table M. The conducting salt concentrations, LiPF₆ and LiFSI, are relative to the solvent volume, i.e. of EC and EMC.

TABLE M
Electrolyte Formulations for Li-ion cells

| | LiPF₆ | LiFSI | PFPN | TPPF | EFOC |
|---|---|---|---|---|---|
| Electrolyte | Molarity | Molarity | (wt %) | (wt %) | (wt %) |
| CE7 | 1.0 | 0.0 | 0.0 | 0.0 | 0.0 |
| CE8 | 1.0 | 0.0 | 7.0 | 0.0 | 0.0 |
| CE9 | 0.8 | 0.2 | 7.0 | 0.0 | 0.0 |
| CE10 | 0.8 | 0.2 | 7.0 | 2.0 | 0.0 |
| EE5 | 0.8 | 0.2 | 3.0 | 5.0 | 0.5 |
| EE6 | 1.0 | 0.0 | 3.0 | 5.0 | 0.5 |

The transport properties of the prepared electrolyte formulations, i.e. the dynamic viscosity and ionic conductivity, were measured. The ionic conductivity was measured with a Metrohm 856 Conductivity Module within an argon glove box at 25° C. to prevent water contamination from influencing the results. The dynamic viscosity, otherwise referred to a simply “viscosity”, was measured with a Brookfield DV2TLV Viscometer at 25° C. with a closed cup and spindle method. Samples for measurement were taken from the same batch of a given electrolyte formulation. The results are summarized in Table N.

TABLE N
Measured transport properties of electrolyte
formulations for Li-ion cells.

| | Ionic Conductivity | Viscosity |
|---|---|---|
| Electrolyte | (mS/cm, 25° C.) | (cP, 25° C.) |
| CE7 | 7.9 | 3.5 |
| CE8 | 7.6 | 3.9 |
| CE9 | 7.6 | 3.9 |
| CE10 | 6.3 | 4.2 |
| EE5 | 6.9 | 4.8 |
| EE6 | 7.0 | 3.9 |

The Comparative Example electrolyte formulations CE7, CE8 and CE9 demonstrate higher ionic conductivity and lower viscosity. These transport properties are generally understood in the art to result in better performance in lithium-ion batteries. The inclusion of TPPF in EE5 and EE6 only results in at most a 0.7 mS/cm difference in ionic conductivity. However, battery performance is not a mere function of electrolyte formulation transport properties. Superior performance is a function of the resulting CEI and SEI that form from specifically chosen additives within the electrolyte formulation, especially EFOC. The unexpected results are further discussed below.

### Example 8—NMC/Graphite Cell Data

The electrolyte formulations prepared are used as electrolytes in 3500 mAh Li-ion pouch cells comprising Li Ni_{0.8}Mn_{0.1}Co_{0.1}O₂, (NMC) cathode active material. The anode material comprises natural graphite mixed with artificial graphite in a 7:3 ratio; with SiOx mixed in at a ratio of 5:95 of SiO to graphite. The nominal voltage is rated to be 3.7 V and weigh approximately 53 g, amounting to a specific energy density of 244 Wh/kg. A polyethylene film is used as a separator. In each cell, 6.8 g of electrolyte formulation was added and allowed to soak in the cell for 1 hour. The cells are vacuum sealed, and primary charged before wetting at 25° C. for 24 hours. The cells were then charged to 3.65 V at C/10 rate at 25° C. before degassing, followed by vacuum sealing. The cells are then allowed to idle for additional wetting at 45° C. for 24 hours. The cells were charged and discharged twice between 4.2 to 3.0 V at C/3 rate at 25° C. The alternating current internal resistance (AC-IR) is measured at 100% SOC with a Hioki battery impedance meter. The results are summarized in Table O.

With the addition of 0.5 wt. % EFOC, the initial cell data of EE5 and EE6 are comparable to comparative examples and the nominal capacity of the cells is achieved. It is observed that the inclusion of the safety molecules, PFPN and TPPF, that resistance rises relative to CE7 that does not comprise them. Furthermore, it is observed that the incorporation of EFOC reduces the resistance of the cells relative to the comparative examples CE8 and CE10.

TABLE O
Initial Cell Data for NMC/Graphite cells

| | 1^{st} Coulombic | Formation Discharge | |
|---|---|---|---|
| | Efficiency | Capacity | AC-IR |
| Electrolyte | (%) | (mAh) | (mΩ) |
| CE7 | 89.2 | 3528 | 6.93 |
| CE8 | 89.1 | 3516 | 7.56 |
| CE9 | 88.9 | 3469 | 7.23 |
| CE10 | 88.6 | 3498 | 7.49 |
| EE5 | 89.2 | 3522 | 7.28 |
| EE6 | 88.9 | 3528 | 7.53 |

After the activation and formation procedure the cells are subjected to a High Power Pulse Charging (HPPC) test. The power capabilities of the cell, and how it correlates to the electrolyte formulation therein, can be deduced from this test. The chief result of this test is the discharge direct current internal resistance (DCIR) collected by applying a 30 second 1.3C discharge pulse to the cell and measuring the voltage drop of the cell, this is done at 50% state-of-charge (SOC). This is then followed by a charge pulse at C/5 to return the cell to 50% SOC. The charge DCIR collected by applying a 30 second 1.3C charge pulse to the cell and measuring the voltage rise of the cell, this will have occurred at 50% SOC. The results are summarized in Table P.

TABLE P
HPPC data for NMC/Graphite cells

| Electrolyte | Discharge DCIR (mΩ) | Charge DCIR (mΩ) |
|---|---|---|
| CE7 | 20.0 | 19.8 |
| CE8 | 21.9 | 21.6 |
| CE9 | 21.7 | 21.2 |
| CE10 | 22.4 | 22.3 |
| EE5 | 20.4 | 20.5 |
| EE6 | 21.1 | 20.5 |

It is observed that the inclusion of PFPN and TPPF increases the DCIR for CE8-10 in view of CE7 that does not comprise them. However, the incorporation of EFOC unexpectedly reduces the resistance of EE5 and EE6, comparing to CE8-10.

It is generally understood in the art that transport properties dominate the power capability of a cell—better transport properties of the electrolyte formulation will expectedly result in cells with superior performances, such as lower DCIR. As discussed in Table N, the two measured transport properties in the present application are ion conductivity and viscosity. Despite the transport properties of EE5 and EE6 fall within the range as the Comparative Examples, the DCIR of EE5 and EE6 are markedly lower than CE8-10. This surprising and unexpected performance show that a tailored SEI and CEI can overcome shortcomings in viscosity to achieve superior power by having a low-impedance interface for the uninhibited intercalation and de-intercalation of lithium-ions.

After the activation and formation procedure the cells are subjected to a cycle life test. The cells are then charged and discharged 600 times between 4.2V to 3.0 V at 1.0 C charge and discharge rate at 45° C. The relative discharge capacity versus cycle count is displayed in FIG. 5 and summarized in Table Q.

TABLE Q
Capacity Retention data for NMC/Graphite cells

| | Capacity Retention | Capacity Retention |
|---|---|---|
| Electrolyte | after 300 Cycles (%) | after 600 Cycles (%) |
| CE7 | 93.9 | 73.7 |
| CE8 | 81.7 | 72.8 |
| CE9 | 92.0 | 72.4 |
| CE10 | 92.9 | 76.2 |
| EE6 | 94.7 | 77.0 |

The cycle life characteristics as shown in FIG. 5, wherein EE6 outperforms all Comparative Examples for 600 cycles through improved capacity retention. It is also noted that CE10, while similarly comprising TPPF, was less effective than EE6. The high viscosity of CE10 and EE6 should theoretically cause impedance growth over cycles due to polarization of the cell electrolyte and lithium-ions failing to leave the anode. However, unexpectedly, the formation of a superior CEI allows EE6 to lose less capacity to oxidative side-reactions, and thus retain capacity better relative to the Comparative Examples. The lower resistance of the resulting CEI from EE6 also enables its better cycling performances.

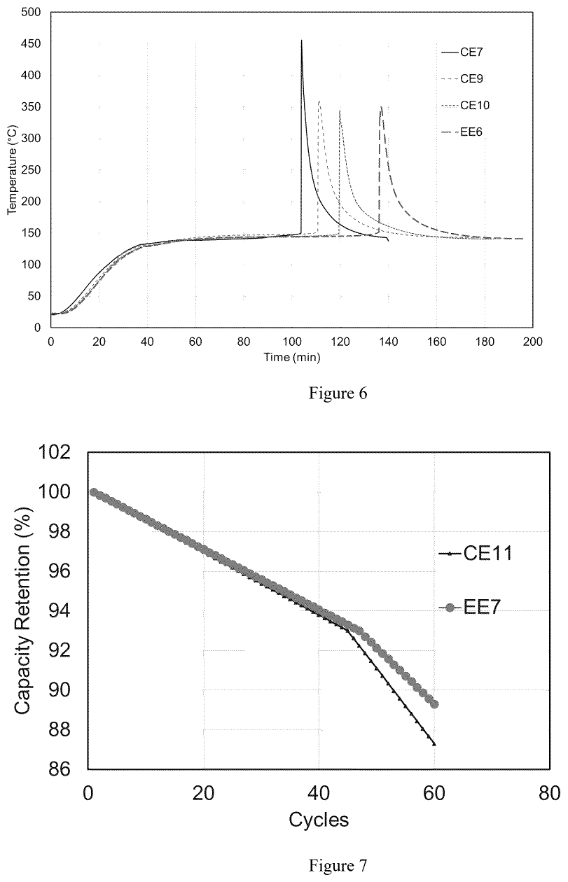

After the activation and formation procedure the cells are subjected to a hotbox test. The purpose of this test is to evaluate the thermal stability of the cell. The cells are charged at a C/10 rate to 100% SOC to ensure that the cathode is fully delithiated and that the cell potential energy is at its highest. A Type K thermocouple is placed on the center of the flat surface of the cell to measure its temperature response; the signal is logged on a Hioki datalogger. The cells are then affixed between ⅛″ aluminum plates to hold the cell and thermocouple in place as it is expected to expand during the hotbox test. The fixtured cell is placed within a forced convection heating chamber, which is in turn located in a fume hood. The oven is set to a ramp rate of 5° C./min with a target temperature of 140° C. The results are displayed in FIG. 6 and displayed in Table R.

TABLE R
Maximum recorded temperature and the time at
which it was measured during a hotbox test

| Electrolyte | Time to Max Temp. (min) | Max Temp. (° C.) |
|---|---|---|
| CE7 | 103 | 456 |
| CE9 | 113 | 361 |
| CE10 | 120 | 344 |
| EE6 | 137 | 349 |

The hotbox test begins with all cells within the chamber at room temperature, after which the temperature of the cell begins to rise to equilibrate with the target temperature of the chamber. As shown in FIG. 6, all cells equilibrate with the chamber at roughly 50 minutes. However, at 140° C. lithium-ion cells are understood to self-heat from exothermic side-reactions predominantly at the interface between the delithiated cathode and the electrolyte formulation. Further, the polyolefin separator is expected to begin to melt at this temperature, so any additional heat and elevated temperature will cause the separator in these cells to melt and cause a catastrophic short releasing all the energy in the cell at near instantaneous time scales. It is then the objective for a safer electrolyte formulation to either inhibit or reduce the overall rate of self-heating in the cell in abuse conditions, in particular high temperatures such as 140° C., so as to not contribute to an irreversible separator failure.

As shown in FIG. 5 and Table R, the tested electrolyte formulations all demonstrate sudden high temperatures at various times past 50 minutes. These sudden high temperatures are the cell entering thermal runaway and the cells disassembling. It can then be reasoned that the cell that has the longest delay in thermal runaway, or no thermal runaway at all, is a safer electrolyte formulation that enables a safer cell. Looking at CE7 versus CE9, the inclusion of PFPN results in a 10 minute advantage, and then comparing CE9 and CE7, the inclusion of TPPF results in another 7 minute safety advantage. The embodiment example EE6 demonstrates a synergy between PFPN and TPPF and the cathode stabilizing additive EFOC, resulting in a cell that delays self-heating for an additional 34 minutes relative to CE7, a 33% increase.

### Example 9—Electrolytes for LCO/Graphite Cells

Electrolyte formulations were prepared in a dry argon filled glovebox by combining all the electrolyte components in a glass vial and stirring for 24 hours to ensure a completely homogeneous mixture. The individual components of the electrolyte formulations are ethylene carbonate (EC), propylene carbonate (PC), ethyl propionate (EP), propyl propionate (PP), fluoroethylene carbonate (FEC), 1,3-propanesultone (PaS), 1,3-propenesultone (PeS), 1,3,6-hexacarbonitrile (HTCN), succinonitrile (SN), lithium hexafluorophosphate (LiPF6), lithium difluorophosphate (LFO), and 2,2,4,4-tetrafluoro-6-ethoxy-6-glycidyltricyclophosphazene (EFOC). The base formulation for all formulations tested was 1.2M LiPF6 in EC/PC/EP/PP 20/10/40/30 weight basis solvent, with 4% PaS, 0.3% PeS, 7% FEC, 2% SN, and 3% HTCN. The embodiment example uses the representative example molecule EFOC as per the present disclosure at a concentration of 0.5 weight percent and is readily miscible in the solution. The electrolyte components and additives used are summarized in Table S.

TABLE S
Electrolyte Formulations for Li-ion cells

| Electrolyte | Additive |
|---|---|
| Comparative Example 11 | None |
| (CE111) | |
| Embodiment Example 7 | 0.5 wt % EFOC |
| (EE7) | |

### Example 10—LCO/Graphite+Si-Carbon Composite Cell Data

The electrolyte formulations prepared are used as electrolytes in CR2032 Li-ion coin cells. The cathode is a coating of active material and binder on an aluminum current collector. The cathode active material comprises lithium cobalt oxide (LCO) and has a capacity of 171 mAh/g. The specific energy of the cathode active material is 0.65 mWh/g. The anode is a coating of active material and binder on a copper current collector. The anode active material is a mix of artificial graphite and Si-Carbon composite particles in a mass ratio of 17:3 graphite to Si-Carbon composite. The anode active material, a Si-Carbon composite particle, consists of a hard carbon scaffolding in which amorphous nano-sized silicon resides. The effective capacity of the anode active materials is 550 mAh/g. A conventional polyethylene film is used as a separator. In each cell, excess electrolyte formulation was added and allowed to soak in the cell for at least 1 hour. The cells were then charged and discharged sixty times between 4.52 to 3.0 V at C/1 charge and discharge rate at 45° C. The results are summarized in Table T and the relative discharge capacity versus cycle count is displayed in FIG. 7.

TABLE T
Capacity and Energy Retention data for LCO/
Graphite + Si-Carbon composite cells.

| | Capacity Retention | Energy Retention |
|---|---|---|
| Electrolyte | after 60 Cycles (%) | after 60 Cycles (%) |
| CE11 | 87.3 | 86.7 |
| EE7 | 89.3 | 88.5 |

The cycle life characteristics as shown in FIG. 7 show that EE7 can outperform the comparative example for 60 cycles through improved capacity retention. The formation of a superior CEI with EFOC allows for a cell to lose less capacity and energy to the extreme oxidative side-reactions that occur at voltages above 4.5 at 45° C. and thus retain capacity better relative to the comparative example.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follows.

What is claimed is:

1. An electrolyte formulation comprising:
an aprotic organic solvent;
a lithium salt;
an additive that reduces between 0.8 and 2.5V relative to lithium; and
an epoxide functionalized organic compound represented by formula (I): 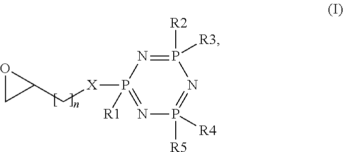
wherein:
n is an integer from 1 to 8;
X is oxygen or sulfur;
R1, R2, R3, R4, and R5 are independently selected from a halogen atom, an optionally substituted C₁-C₁₂ alkyl ether, an optionally substituted C₆-C₁₄ aryl ether, an optionally substituted C₁-C₁₂ alkyl thioether, an optionally substituted C₆-C₁₄ aryl thioether, an optionally substituted C₁-C₁₂ alkyl, and an optionally substituted C₆-C₁₄ aryl,
wherein any hydrogen or carbon atom can be unsubstituted or can be substituted with an epoxide, halogen, alkyl, alkoxy, perfluorinated alkyl, silyl, siloxy, silane, sulfoxide, amide, azo, ether, and thioether group, or a combination thereof.

2. The electrolyte formulation of claim 1, wherein the epoxide functionalized organic compound represented by formula (I) comprises 2,2,4,4-tetrafluoro-6-ethoxy-6-glycidyltricyclophosphazene, 1,1,3,5-tetrafluoro-3,5-diglycidoxycyclotriphosphazene, 1,3,5-trifluoro-1,3,5-triglycidoxycyclotriphosphazene, glycidyl pentafluorophosphazene, or a mixture thereof.

3. The electrolyte formulation of claim 1, wherein the epoxide functionalized organic compound represented by formula (I) has a concentration of from 0.01 wt. % to 10 wt. % of the electrolyte formulation.

4. The electrolyte formulation of claim 1, wherein the aprotic organic solvent comprises ethylene carbonate, fluoroethylene carbonate, propylene carbonate, vinylene carbonate, vinyl ethyl carbonate, ethyl methyl carbonate, diethyl carbonate, dimethyl carbonate, ethyl propionate, propyl propionate, or a mixture thereof.

5. The electrolyte formulation of claim 1, wherein the aprotic organic solvent has a concentration of 60 wt. % to 90 wt. % of the electrolyte formulation.

6. The electrolyte formulation of claim 1, wherein the lithium salt comprises lithium hexafluorophosphate, lithium tetrafluoroborate, lithium difluoro(oxalato)borate, lithium bis(fluorosulfonyl)imide, lithium bis(trifluoromethylsulfonyl)imide, lithium bis(oxalato)borate, lithium difluorophosphate, or a mixture thereof.

7. The electrolyte formulation of claim 1, wherein the lithium salt has a concentration of 10 wt. % to 30 wt. % of the electrolyte formulation.

8. The electrolyte formulation of claim 1, wherein the additive that reduces between 0.8 and 2.5V relative to lithium is an organosulfur compound.

9. The electrolyte formulation of claim 8, wherein the organosulfur compound comprises 1,3-propanesultone, 1,3-propenesultone, methylene methanedisulfonate, ethylene sulfite, ethylene sulfate, 1,3,6,9,12-pentaoxa-2-thiacyclotetradecane-2,2-dioxide, or a mixture thereof.

10. The electrolyte formulation of claim 1, wherein the additive that reduces between 0.8 and 2.5V relative to lithium has a concentration of 0.1 wt. % to 10 wt. % of the electrolyte formulation.

11. The electrolyte formulation of claim 1 further comprising an additional alkyl nitrile compound selected from the group consisting of adiponitrile, succinonitrile, valeronitrile, 1,3,6-hexanetricarbonitrile, 1,2,6-hexanetricarbonitrile, and mixtures thereof.

12. The electrolyte formulation of claim 11, wherein the alkyl nitrile compound has a concentration of 0.1 wt. % to 10 wt. % of the electrolyte formulation.

13. An energy storage device comprising:
a cathode;
an anode;
a separator; and
and an electrolyte formulation according to claim 1.

14. The device of claim 13, wherein the cathode comprises LiCoO₂, LiNiO₂, LiMn_{0.5}Ni_{0.5}O₂, Li Ni_{0.8}Mn_{0.1}Co_{0.1}O₂, Li Ni_{0.6}Mn_{0.2}Co_{0.2}O₂, LiNi_{0.5}Mn_{0.3}Co_{0.2}O₂, Li Ni_{0.33}Mn_{0.33}Co_{0.33}O₂, LiMn₂O₄, LiFePO₄, and LiNiₓCo_{y}Mn_{z}O₂ wherein x, y, and z sum to 1, or a mixture thereof.

15. The device of claim 13, wherein the cathode comprises LiCoO₂ and the cut-off voltage of the device is at least 4.4V.

16. The device of claim 13, wherein the anode comprises lithium metal, graphitic material, amorphous carbon, Li₄Ti₅O₁₂, tin alloy, silicon, silicon oxide, silicon alloy, silicon-carbon composite, or a mixture thereof.

17. The device of claim 13, wherein the anode is a composite anode comprising an active material silicon, silicon alloys, silicon-carbon composite, or combinations thereof; and a conductive polymer coating around the active material.

18. The device of claim 13, wherein the conductive polymer is polyacrylonitrile (PAN).

19. The device of claim 13, wherein the separator comprises a porous separator separating the anode and cathode from each other.

20. The device of claim 13, wherein the porous separator comprises a micro-porous polyolefin separator or a microporous polymer film comprising nylon, cellulose, nitrocellulose, polysulfone, polyacrylonitrile, polyvinylidene fluoride, polypropylene, polyethylene, polybutene, or a co-polymer or a blend of any two or more such polymers.
